(19) United States
(12) Patent Application Publication
(10) Pub. No.: US 2025/0273393 A1
(43) Pub. Date: Aug. 28, 2025

(54) METHOD FOR MANUFACTURING ELECTRONIC COMPONENT

(71) Applicant: TDK Corporation, Tokyo (JP)

(72) Inventors: Shunji Aoki, Tokyo (JP); Yusuke Onezawa, Tokyo (JP); Eito Asakura, Tokyo (JP); Hirotaka Miura, Tokyo (JP)

(73) Assignee: TDK Corporation, Tokyo (JP)

(21) Appl. No.: 19/052,924

(22) Filed: Feb. 13, 2025

(30) Foreign Application Priority Data
Feb. 22, 2024 (JP) 2024-025255

(51) Int. Cl. H01F 41/04; H01F 5/00; H01F 27/29

(52) U.S. Cl. CPC H01F 41/041; H01F 5/003; H01F 27/292

(57) ABSTRACT

In a method for manufacturing a coil component, in a step of forming a plurality of green sheets, a process of forming, using an insulating paste, an element-body pattern having a defective portion and a process of forming, using a conductor paste, a conductor pattern having protrusions protruding from a surface of the element-body pattern in the defective portion of the element-body pattern are performed to form at least one first green sheet of the plurality of green sheets, the conductor pattern includes a plurality of regions A having different height positions with respect to the surface of the element-body pattern, and the protrusions are formed in the conductor pattern by the region protruding from the surface of the element-body pattern in the plurality of regions.

### TECHNICAL FIELD

The present disclosure relates to a method for manufacturing an electronic component.

### BACKGROUND

An electronic component is manufactured including a step of forming a sheet including an insulating layer and a conductor layer, and a step of stacking a plurality of the sheets to form a stacked body (see, for example, Japanese Unexamined Patent Publication No. 2018-113309).

### SUMMARY

An object of one aspect of the present disclosure is to provide a method for manufacturing an electronic component capable of suppressing stacking misalignment of sheets in a stacked body.

(1) A method for manufacturing an electronic component according to one aspect of the present disclosure includes the steps of: forming a plurality of sheets; and stacking the plurality of sheets to form a stacked body, in which in the step of forming the plurality of sheets, a process of forming, using an insulating paste, a first insulating layer having an opening and a process of forming, using a conductor paste, a first conductor layer having a protrusion protruding from a surface of the first insulating layer in the opening of the first insulating layer are performed to form at least one first sheet of the plurality of sheets, the first conductor layer includes a plurality of regions having different height positions with respect to the surface of the first insulating layer, and the protrusion is formed in the first conductor layer by the region protruding from the surface of the first insulating layer in the plurality of regions.

In the method for manufacturing an electronic component according to the aspect of the present disclosure, the first sheet having the first conductor layer is formed as at least one sheet of the plurality of sheets. The first conductor layer has the protrusion protruding from the surface of the first insulating layer. As a result, in the method for manufacturing an electronic component, when the first sheet and another sheet are stacked, the protrusion of the first conductor layer bites into another sheet. Therefore, in the method for manufacturing an electronic component, the movement of the first sheet in a direction (direction along the insulating layer of the sheet) orthogonal to a stacking direction with respect to another sheet can be restricted by an anchor effect. Therefore, in the method for manufacturing an electronic component, stacking misalignment of the sheets in the stacked body can be suppressed.

(2) In the method for manufacturing an electronic component according to (1), in the step of forming the plurality of sheets, a process of forming, using an insulating paste, a second insulating layer having an opening and a process of forming, using a conductor paste, a second conductor layer in the opening of the second insulating layer may be performed to form at least one second sheet of the plurality of sheets, and in the step of forming the stacked body, the first sheet and the second sheet may be stacked so that the protrusion of the first conductor layer of the first sheet overlaps the second conductor layer of the second sheet. In this method, the protrusion of the first conductor layer bites into the second conductor layer. Therefore, the movement of the first sheet with respect to the second sheet can be more reliably restricted.

(3) In the method for manufacturing an electronic component according to (1) or (2), in the step of forming the plurality of sheets, a process of forming a second insulating layer using an insulating paste may be performed to form at least one second sheet of the plurality of sheets, and in the step of forming the stacked body, the first sheet and the second sheet may be stacked so that the protrusion of the first conductor layer of the first sheet overlaps the second insulating layer of the second sheet. In this method, the protrusion of the first conductor layer bites into the second insulating layer. Therefore, the movement of the first sheet with respect to the second sheet can be more reliably restricted.

(4) In the method for manufacturing an electronic component according to any one of (1) to (3), in the step of forming the plurality of sheets, a process of forming a third insulating layer using an insulating paste may be performed to form at least one third sheet of the plurality of sheets, and the third sheet may be stacked so as to be an outermost layer in a stacking direction of the stacked body, and an outer surface of the stacked body may be configured by the third sheet. In this method, the outer surface of the stacked body can be configured by the third sheet.

(5) In the method for manufacturing an electronic component according to any one of (1) to (4), in the first sheet, the protrusion may be formed so as to cover at least a part of an edge of the first insulating layer forming the opening in the first insulating layer. In this method, the protrusion is also formed at the edge of the first insulating layer. Therefore, the bonding strength between the first insulating layer and the first conductor layer can be improved.

(6) In the method for manufacturing an electronic component according to (1), the first conductor layer having a recess recessed from the surface of the first insulating layer may be formed in the first sheet, and the recess may be formed in the first conductor layer by the region recessed from the surface of the first insulating layer in the plurality of regions. In this method, the surface area of the first conductor layer can be increased by forming the recess in the first conductor layer.

(7) In the method for manufacturing an electronic component according to (1), the first conductor layer may constitute a coil conductor. In this method, a coil component can be manufactured as an electronic component.

According to the aspect of the present disclosure, stacking misalignment of the sheets in the stacked body can be suppressed.

### BRIEF DESCRIPTION OF THE DRAWINGS

FIG. 1 is a perspective view of a coil component manufactured by a method for manufacturing an electronic component according to an embodiment;

FIG. 2 is an exploded perspective view of the coil component illustrated in FIG. 1;

FIG. 3 is a side view of the coil component illustrated in FIG. 1;

FIG. 4 is a flowchart illustrating a method for manufacturing the coil component;

FIGS. 5A, 5B, 5C, 5D, and 5E are diagrams for explaining a method for manufacturing a first green sheet;

FIG. 6 is a diagram illustrating the first green sheet;

FIG. 7 is a diagram for explaining a method for manufacturing a third green sheet;

FIG. 8 is a cross-sectional view illustrating a part of a stacked body;

FIGS. 9A, 9B, and 9C are diagrams for explaining a method for manufacturing a second green sheet;

FIG. 10 is a cross-sectional view illustrating a part of the stacked body;

FIGS. 11A, 11B, 11C, 11D, and 11E are diagrams for explaining a method for manufacturing a green sheet for a coil component according to another embodiment;

FIGS. 12A, 12B, 12C, and 12D are diagrams illustrating a first green sheet;

FIGS. 13A, 13B, 13C, 13D, and 13E are diagrams for explaining a method for manufacturing a green sheet for a coil component according to another embodiment; and

FIGS. 14A and 14B are diagrams illustrating a first green sheet.

### DETAILED DESCRIPTION

Hereinafter, preferred embodiments of the present invention will be described in detail with reference to the accompanying drawings. Note that the same or corresponding elements in the description of the drawings are denoted by the same reference signs, and redundant description thereof is omitted.

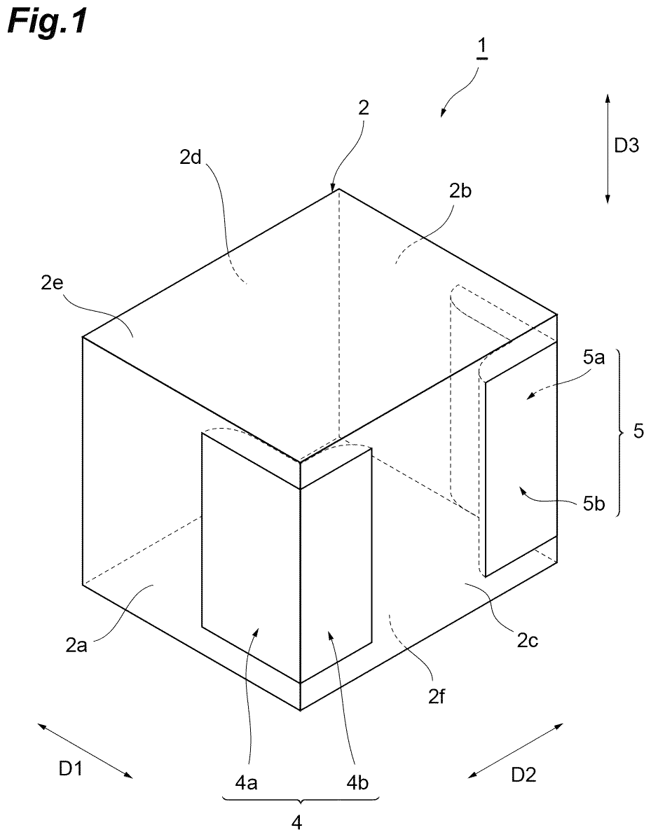

FIG. 1 is a perspective view of a coil component manufactured by a method for manufacturing an electronic component according to an embodiment. As illustrated in FIG. 1, a coil component (electronic component) 1 includes an element body 2 having a rectangular parallelepiped shape and a pair of terminal electrodes 4 and 5. The pair of terminal electrodes 4 and 5 is disposed at both end portions of the element body 2. The rectangular parallelepiped shape includes a rectangular parallelepiped shape in which corner portions and ridge line portions are chamfered, and a rectangular parallelepiped shape in which corner portions and ridge line portions are rounded.

The element body 2 has a pair of end surfaces 2a and 2b facing each other, a pair of main surfaces 2c and 2d facing each other, and a pair of side surfaces 2e and 2f facing each other. A direction in which the pair of main surfaces 2c and 2d faces each other, that is, a direction parallel to the end surfaces 2a and 2b is a first direction D1. A direction in which the pair of end surfaces 2a and 2b faces each other, that is, a direction parallel to the main surfaces 2c and 2d is a second direction D2. A direction in which the pair of side surfaces 2e and 2f faces each other is a third direction D3. In the present embodiment, the first direction D1 is a height direction of the element body 2. The second direction D2 is a longitudinal direction of the element body 2, and is orthogonal to the first direction D1. The third direction D3 is a width direction of the element body 2, and is orthogonal to the first direction D1 and the second direction D2.

The pair of end surfaces 2a and 2b extends in the first direction D1 to couple the pair of main surfaces 2c and 2d. The pair of end surfaces 2a and 2b also extends in the third direction D3, that is, in a short side direction of the pair of main surfaces 2c and 2d. The pair of side surfaces 2e and 2f extends in the first direction D1 to couple the pair of main surfaces 2c and 2d. The pair of side surfaces 2e and 2f also extends in the second direction D2, that is, in a long side direction of the pair of end surfaces 2a and 2b. The coil component 1 is solder-mounted on an electronic device (for example, a circuit board or an electronic component), for example. In the coil component 1, the main surface 2c constitutes a mounting surface facing the electronic device.

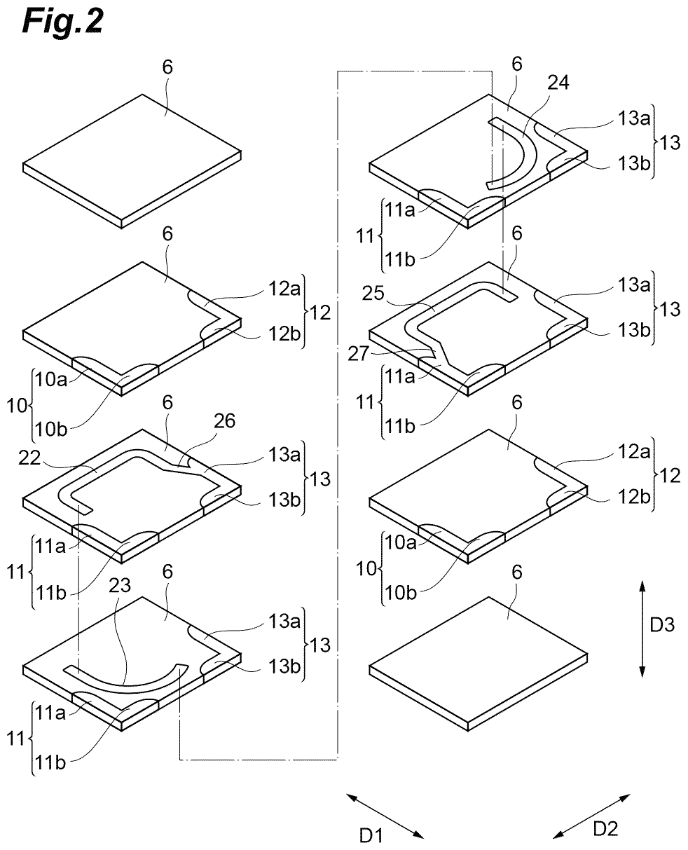

As illustrated in FIG. 2, the element body 2 is configured by stacking a plurality of insulator layers 6 in the third direction D3. The element body 2 has the plurality of stacked insulator layers 6. In the element body 2, the direction in which the plurality of insulator layers 6 are stacked coincides with the third direction D3. In the actual element body 2, the insulator layers 6 are integrated to such an extent that boundaries between the insulator layers 6 cannot be visually recognized.

Each of the insulator layers 6 is formed of a dielectric material containing a glass component. That is, the element body 2 contains the dielectric material containing a glass component as a compound of elements constituting the element body 2. The glass component is, for example, borosilicate glass. Examples of the dielectric material include a BaTiO₃-based, Ba(Ti, Zr)O₃-based, or (Ba, Ca)TiO₃-based dielectric ceramic. Each of the insulator layers 6 includes a sintered body of a ceramic green sheet containing a glass ceramic material.

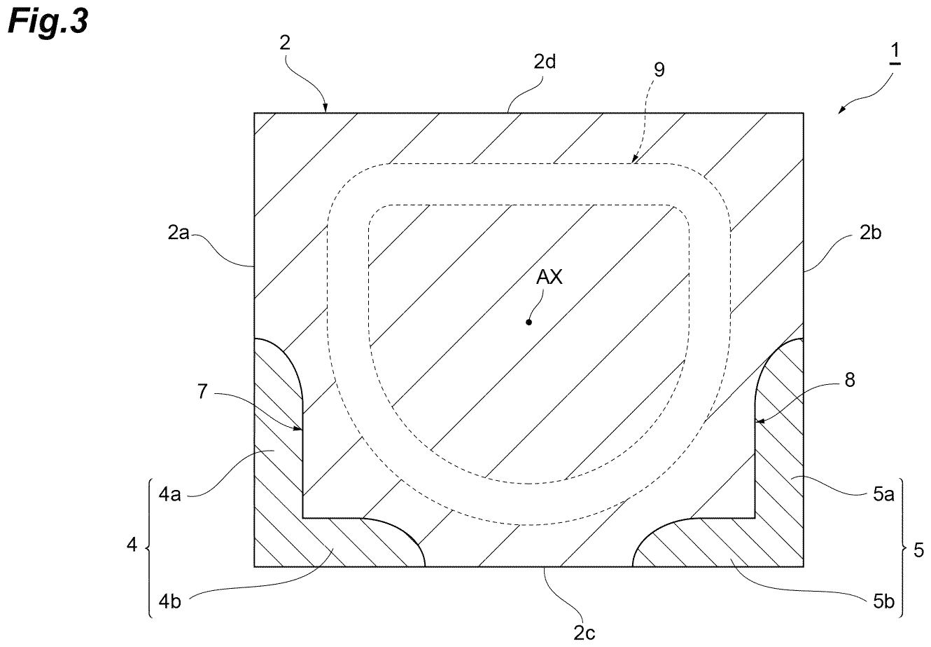

As illustrated in FIG. 3, the element body 2 has recesses 7 and 8. The recess 7 is provided on the end surface 2a side of the element body 2. The recess 7 is a space recessed inward from an outer surface of the element body 2. The recess 7 has a shape corresponding to the shape of the terminal electrode 4. In the present embodiment, the recess 7 has an L shape as viewed from the third direction D3. The recess 8 is provided on the end surface 2b side of the element body 2. The recess 8 is a space recessed inward from the outer surface of the element body 2. The recess 8 has a shape corresponding to the shape of the terminal electrode 5. In the present embodiment, the recess 8 has an L shape as viewed from the third direction D3.

As illustrated in FIG. 3, the terminal electrodes 4 and 5 are embedded in the element body 2. The terminal electrode 4 is disposed on the end surface 2a side of the element body 2. The terminal electrode 4 is disposed in the recess 7 of the element body 2. The terminal electrode 5 is disposed on the end surface 2b side of the element body 2. The terminal electrode 5 is disposed in the recess 8 of the element body 2.

The terminal electrode 4 is disposed over the end surface 2a and the main surface 2c. The terminal electrode 5 is disposed over the end surface 2b and the main surface 2c. In the present embodiment, the surface of the terminal electrode 4 is substantially flush with each of the end surface 2a and the main surface 2c. The surface of the terminal electrode 5 is substantially flush with each of the end surface 2b and the main surface 2c.

The terminal electrode 4 has an L shape as viewed from the third direction D3. The terminal electrode 4 has a plurality of electrode portions 4a and 4b. In the present embodiment, the terminal electrode 4 has a pair of the electrode portions 4a and 4b. The electrode portion 4a and the electrode portion 4b are connected at a ridge line portion of the element body 2 and are electrically connected to each other. In the present embodiment, the electrode portion 4a and the electrode portion 4b are integrally formed. The electrode portion 4a extends along the first direction D1. The electrode portion 4a has a rectangular shape as viewed from the second direction D2. The electrode portion 4b extends along the second direction D2. The electrode portion 4b has a rectangular shape as viewed from the first direction D1. Each of the electrode portions 4a and 4b extends along the third direction D3.

As illustrated in FIG. 2, the terminal electrode 4 is configured by stacking a plurality of electrode layers 10 and a plurality of electrode layers 11. In the present embodiment, the number of electrode layers 10 is “2”, and the number of electrode layers 11 is “4”. The electrode layers 10 are disposed at positions sandwiching the electrode layers 11 in the third direction D3.

Each of the electrode layers 10 is provided in a defective portion formed in the corresponding insulator layer 6. The defective portion constitutes the recess 7. The electrode layer 10 is formed by firing a conductive paste. The conductive paste contains a metal component. The metal component is contained in a conductive material, and is, for example, Ag or Pd. The conductive paste may contain a glass component. The glass component is a compound of elements constituting the element body 2, and may be the same component as the glass component contained in the element body 2. The content of the glass component may be appropriately set. Each of the electrode layers 10 has an L shape as viewed from the third direction D3. The electrode layer 10 has layer portions 10a and 10b. The layer portion 10a extends along the first direction D1. The layer portion 10b extends along the second direction D2.

Each of the electrode layers 11 is provided in a defective portion formed in the corresponding insulator layer 6. The defective portion constitutes the recess 7. The electrode layer 11 is formed by firing a conductive paste. The conductive paste contains a conductive material. The conductive material is, for example, Ag or Pd. Each of the electrode layers 11 has an L shape as viewed from the third direction D3. The electrode layer 11 has layer portions 11a and 11b. The layer portion 11a extends along the first direction D1. The layer portion 11b extends along the second direction D2.

The electrode portion 4a is configured by stacking the layer portions 10a and 11a of the electrode layers 10 and 11. In the electrode portion 4a, the layer portions 10a and 11a are integrated to such an extent that boundaries between the layer portions 10a and 11a cannot be visually recognized. The electrode portion 4b is configured by stacking the layer portions 10b and 11b of the electrode layers 10 and 11. In the electrode portion 4b, the layer portions 10b and 11b are integrated to such an extent that boundaries between the layer portions 10b and 11b cannot be visually recognized.

As illustrated in FIG. 3, the terminal electrode 5 has an L shape as viewed from the third direction D3. The terminal electrode 5 has a plurality of electrode portions 5a and 5b. In the present embodiment, the terminal electrode 5 has a pair of the electrode portions 5a and 5b. The electrode portion 5a and the electrode portion 5b are connected at a ridge line portion of the element body 2 and are electrically connected to each other. In the present embodiment, the electrode portion 5a and the electrode portion 5b are integrally formed. The electrode portion 5a extends along the first direction D1. The electrode portion 5a has a rectangular shape as viewed from the second direction D2. The electrode portion 5b extends along the second direction D2. The electrode portion 5b has a rectangular shape as viewed from the first direction D1. Each of the electrode portions 5a and 5b extends along the third direction D3.

As illustrated in FIG. 2, the terminal electrode 5 is configured by stacking a plurality of electrode layers 12 and a plurality of electrode layers 13. In the present embodiment, the number of electrode layers 12 is “2”, and the number of electrode layers 13 is “4”. The electrode layers 12 are disposed at positions sandwiching the electrode layers 13 in the third direction D3.

Each of the electrode layers 12 is provided in a defective portion formed in the corresponding insulator layer 6. The defective portion constitutes the recess 8. The electrode layer 12 is formed by firing a conductive paste. The conductive paste contains a metal component. The metal component is contained in a conductive material, and is, for example, Ag or Pd. The conductive paste may contain a glass component. The glass component is a compound of elements constituting the element body 2, and may be the same component as the glass component contained in the element body 2. Each of the electrode layers 12 has an L shape as viewed from the third direction D3. The electrode layer 12 has layer portions 12a and 12b. The layer portion 12a extends along the first direction D1. The layer portion 12b extends along the second direction D2.

Each of the electrode layers 13 is provided in a defective portion formed in the corresponding insulator layer 6. The defective portion constitutes the recess 8. The electrode layer 13 is formed by firing a conductive paste. The conductive paste contains a conductive material. The conductive material is, for example, Ag or Pd. Each of the electrode layers 13 has an L shape as viewed from the third direction D3. The electrode layer 13 has layer portions 13a and 13b. The layer portion 13a extends along the first direction D1. The layer portion 13b extends along the second direction D2.

The electrode portion 5a is configured by stacking the layer portions 12a and 13a of the electrode layers 12 and 13. In the electrode portion 5a, the layer portions 12a and 13a are integrated to such an extent that boundaries between the layer portions 12a and 13a cannot be visually recognized. The electrode portion 5b is configured by stacking the layer portions 12b and 13b of the electrode layers 12 and 13. In the electrode portion 5b, the layer portions 12b and 13b are integrated to such an extent that boundaries between the layer portions 12b and 13b cannot be visually recognized.

As illustrated in FIG. 3, the coil component 1 includes a coil 9 disposed in the element body 2. A coil axis AX of the coil 9 extends along the third direction D3.

As illustrated in FIG. 2, the coil 9 includes a first coil conductor 22, a second coil conductor 23, a third coil conductor 24, and a fourth coil conductor 25. The first coil conductor 22, the second coil conductor 23, the third coil conductor 24, and the fourth coil conductor 25 are arranged in the order of the first coil conductor 22, the second coil conductor 23, the third coil conductor 24, and the fourth coil conductor 25 along the third direction D3. The first coil conductor 22, the second coil conductor 23, the third coil conductor 24, and the fourth coil conductor 25 substantially have a shape in which a part of a loop is interrupted, and have one end and the other end. The first coil conductor 22, the second coil conductor 23, the third coil conductor 24, and the fourth coil conductor 25 are formed to have a predetermined width.

The first coil conductor 22 is located in the same layer as one electrode layer 11 and one electrode layer 13. The first coil conductor 22 is coupled to the electrode layer 13 via a coupling conductor 26. The coupling conductor 26 is located in the same layer as the first coil conductor 22. One end of the first coil conductor 22 is connected to the coupling conductor 26. The coupling conductor 26 is connected to the layer portion 13a. The coupling conductor 26 couples the first coil conductor 22 to the electrode layer 13. The coupling conductor 26 may be coupled to the layer portion 13b. The first coil conductor 22 is separated from the electrode layer 11 located in the same layer. In the present embodiment, the first coil conductor 22, the coupling conductor 26, and the electrode layer 13 are integrally formed.

The second coil conductor 23 is located in the same layer as one electrode layer 11 and one electrode layer 13. The second coil conductor 23 is separated from the electrode layers 11 and 13 located in the same layer. The first coil conductor 22 and the second coil conductor 23 are adjacent to each other in the third direction D3. As viewed from the third direction D3, the other end of the first coil conductor 22 and one end of the second coil conductor 23 overlap each other.

The third coil conductor 24 is located in the same layer as one electrode layer 11 and one electrode layer 13. The third coil conductor 24 is separated from the electrode layers 11 and 13 located in the same layer. The second coil conductor 23 and the third coil conductor 24 are adjacent to each other in the third direction D3. As viewed from the third direction D3, the other end of the second coil conductor 23 and one end of the third coil conductor 24 overlap each other.

The fourth coil conductor 25 is located in the same layer as one electrode layer 11 and one electrode layer 13. The fourth coil conductor 25 is coupled to the electrode layer 11 via a coupling conductor 27. The coupling conductor 27 is located in the same layer as the fourth coil conductor 25. The other end of the fourth coil conductor 25 is connected to the coupling conductor 27. The coupling conductor 27 is connected to the layer portion 11a. The coupling conductor 27 couples the fourth coil conductor 25 to the electrode layer 11. The coupling conductor 27 may be connected to the layer portion 11b. The fourth coil conductor 25 is separated from the electrode layer 13 located in the same layer. In the present embodiment, the fourth coil conductor 25, the coupling conductor 27, and the electrode layer 11 are integrally formed.

The third coil conductor 24 and the fourth coil conductor 25 are adjacent to each other in the third direction D3. As viewed from the third direction D3, the other end of the third coil conductor 24 and one end of the fourth coil conductor 25 overlap each other.

The first coil conductor 22, the second coil conductor 23, the third coil conductor 24, and the fourth coil conductor 25 are electrically connected. The first coil conductor 22, the second coil conductor 23, the third coil conductor 24, and the fourth coil conductor 25 constitute the coil 9. The coil 9 is electrically connected to the terminal electrode 5 through the coupling conductor 26. The coil 9 is electrically connected to the terminal electrode 4 through the coupling conductor 27.

The first coil conductor 22, the second coil conductor 23, the third coil conductor 24, the fourth coil conductor 25, and the coupling conductors 26 and 27 contain a conductive material. The conductive material contains Ag or Pd. The first coil conductor 22, the second coil conductor 23, the third coil conductor 24, the fourth coil conductor 25, and the coupling conductors 26 and 27 are configured as sintered bodies of a conductive paste containing conductive material powders. The conductive material powders include, for example, Ag powders or Pd powders.

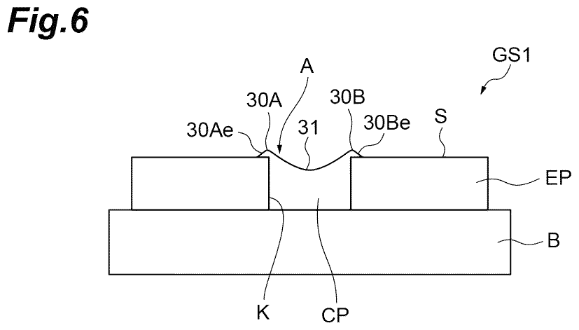

In the present embodiment, the first coil conductor 22, the second coil conductor 23, the third coil conductor 24, the fourth coil conductor 25, and the coupling conductors 26 and 27 contain the same conductive material as the terminal electrodes 4 and 5. The first coil conductor 22, the second coil conductor 23, the third coil conductor 24, the fourth coil conductor 25, and the coupling conductors 26 and 27 may contain a conductive material different from that of the terminal electrodes 4 and 5. The first coil conductor 22, the second coil conductor 23, the third coil conductor 24, the fourth coil conductor 25, and the coupling conductors 26 and 27 are provided in defective portions (openings) K (see FIG. 6) formed in the corresponding insulator layers 6.

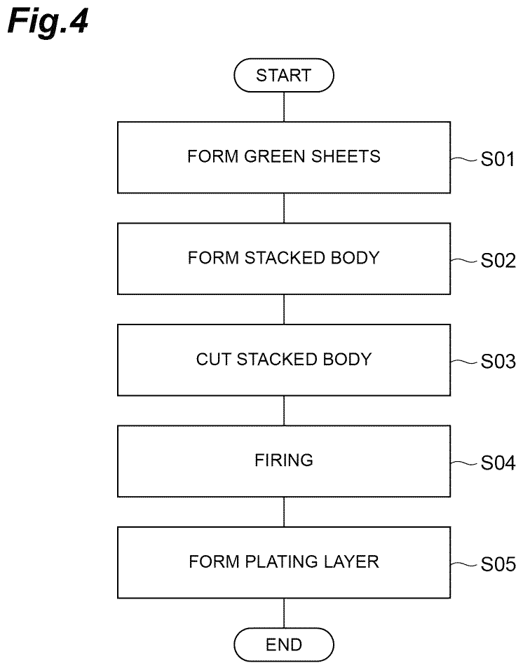

Subsequently, a method for manufacturing the coil component 1 will be described. FIG. 4 is a flowchart illustrating the method for manufacturing the coil component 1.

As illustrated in FIG. 4, a plurality of green sheets are formed (step S01). The green sheet includes an element-body pattern and a conductor pattern. First, a method for forming a first green sheet of the plurality of green sheets will be described.

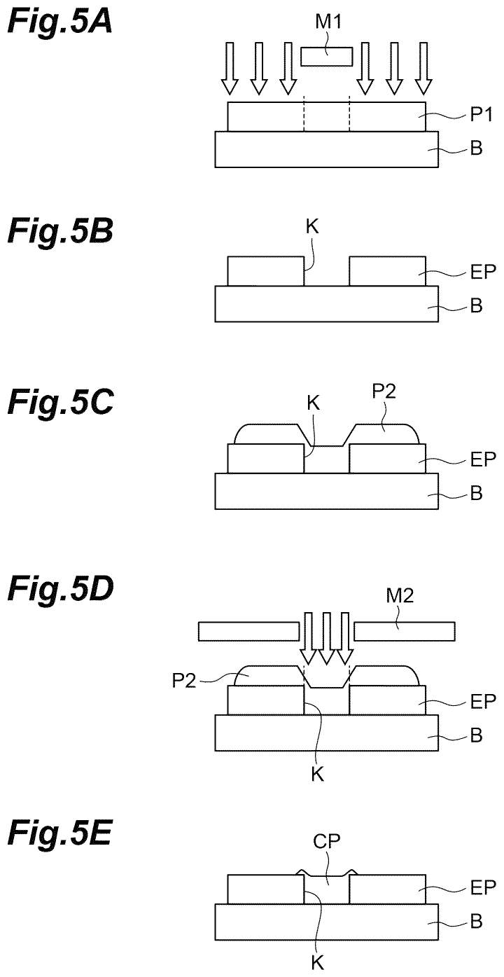

In a step of forming the first green sheet, first, the element-body pattern (first insulating layer) is formed. As illustrated in FIG. 5A, the element-body pattern is formed by applying an element-body paste (insulating paste) P1 containing a constituent material of the insulator layer 6 and a photosensitive material onto a base material B (for example, a PET film). The photosensitive material contained in the element-body paste P1 may be either a negative type or a positive type, and a known photosensitive material can be used. Subsequently, an element-body forming layer is exposed and developed by, for example, a photolithography method using a Cr mask M1, and as illustrated in FIG. 5B, an element-body pattern EP including the defective portion K obtained by removing a shape corresponding to the shape of a conductor pattern CP to be described later is formed on the base material. The defective portion K is formed to penetrate the element-body pattern EP. The element-body pattern EP is a layer that becomes the insulator layer 6 after heat treatment.

Note that the “photolithography method” of the present embodiment may be any method as long as a layer to be processed and containing a photosensitive material is processed into a desired pattern by exposure and development, and the type of mask and the like are not limited. The exposure may be irradiation by a mask exposure apparatus having a UV wavelength or the like as a light source, or a direct lithography apparatus using laser light or the like may be used. At the time of irradiation, a plurality of outputs may be used for each shot.

Next, the conductor pattern (first conductor layer) is formed. As illustrated in FIG. 5C, for the conductor pattern, a conductor material layer is formed by applying a conductor paste P2 containing constituent materials of the electrode layers 10, 11, 12, and 13, the first coil conductor 22, the second coil conductor 23, the third coil conductor 24, the fourth coil conductor 25, and the coupling conductors 26 and 27, and a photosensitive material onto the element-body pattern EP. Specifically, the conductor material layer is formed on the element-body pattern EP and the defective portion K (including the base material B in the defective portion K). The photosensitive material contained in the conductor paste P2 may be either a negative type or a positive type, and a known photosensitive material can be used. Next, as illustrated in FIG. 5D, the conductor material layer is exposed and developed by a photolithography method using a mask M2 corresponding to the defective portion K. As a result, as illustrated in FIG. 5E, the conductor pattern CP corresponding to the shape of the defective portion K is formed.

As described above, the first green sheet (first sheet) GS1 having the element-body pattern EP and the conductor pattern CP is formed. FIG. 6 is a diagram illustrating a part of the first green sheet GS1. As illustrated in FIG. 6, in the first green sheet GS1, the conductor pattern CP has protrusions 30A and 30B and a recess 31. In the present embodiment, the conductor pattern CP has two protrusions 30A and 30B. In the present embodiment, the two protrusions 30A and 30B are provided at both end portions of the conductor pattern CP in a width direction of the conductor pattern CP. The protrusions 30A and 30B protrude from a surface S of the element-body pattern EP.

The conductor pattern CP includes a plurality of regions A having different height positions with respect to the surface S of the element-body pattern EP. The protrusions 30A and 30B are formed of the plurality of regions A. The protrusions 30A and 30B are configured by the region A having a height higher than the surface S of the element-body pattern EP in the plurality of regions A. In the present embodiment, the protrusions 30A and 30B have edge portions 30Ae and 30Be. The edge portions 30Ae and 30Be are disposed on the edge of the element-body pattern EP forming the defective portion K in the element-body pattern EP. The edge portions 30Ae and 30Be may be continuously formed in an extending direction of the conductor pattern CP, or may be intermittently formed.

The recess 31 is recessed from the surface S of the element-body pattern EP. The lowest position of the recess 31 is lower than the height position of the surface of the element-body pattern EP. The recess 31 is configured by the region A having a height lower than the surface S of the element-body pattern EP in the plurality of regions A. In the present embodiment, the recess 31 has a curved shape.

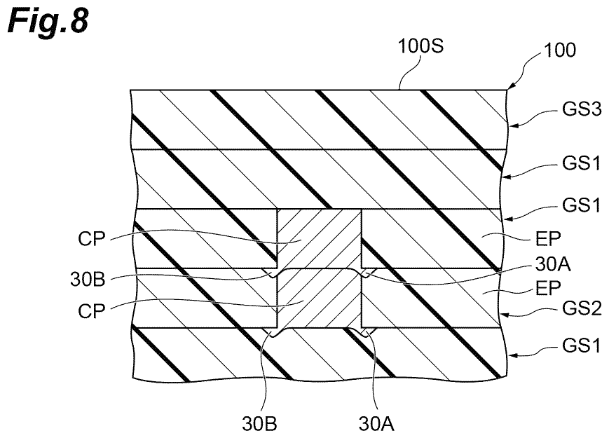

Subsequently, a method for forming a second green sheet GS2 (see FIG. 8) of the plurality of green sheets will be described. In the present embodiment, the second green sheet GS2 has the same configuration as the first green sheet GS1. The second green sheet GS2 can be formed in the same manner as the first green sheet GS1.

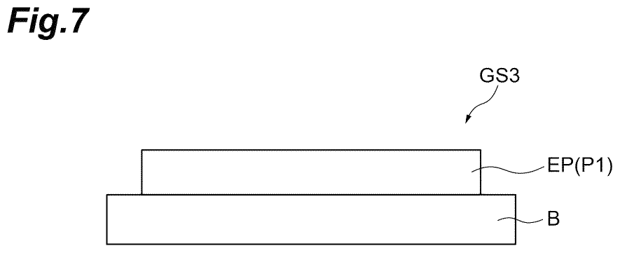

Subsequently, a method for forming a third green sheet of the plurality of green sheets will be described. In a step of forming the third green sheet, the element-body pattern (third insulating layer) EP is formed. As illustrated in FIG. 7, the element-body pattern EP is formed by applying an element-body paste onto a base material. As described above, the third green sheet (third sheet) GS3 including the element-body pattern EP is formed.

Subsequently, a stacked body is formed (step S02). The stacked body 100 is formed by stacking the first green sheet GS1, the second green sheet GS2, and the third green sheet GS3. FIG. 8 is a cross-sectional view illustrating a part of the stacked body 100.

In the example illustrated in FIG. 8, the first green sheet GS1 and the second green sheet GS2 are stacked adjacent to each other. As illustrated in FIG. 8, in the stacked body 100, the first green sheet GS1 and the second green sheet GS2 are stacked so that the conductor patterns CP overlap each other in the first green sheet GS1 and the second green sheet GS2 adjacent to each other. The protrusions 30A and 30B of the conductor pattern CP of the first green sheet GS1 (third from the top in FIG. 8) bite into the conductor pattern CP of the second green sheet GS2 (fourth from the top in FIG. 8). The protrusions 30A and 30B of the conductor pattern CP of the second green sheet GS2 (fourth from the top in FIG. 8) bite into the element-body pattern EP of the first green sheet GS1 (fifth from the top in FIG. 8). The third green sheet GS3 is stacked so as to be the outermost layer in a stacking direction in the stacked body 100. The third green sheet GS3 constitutes an outer surface 100S of the stacked body 100.

Subsequently, as illustrated in FIG. 4, the stacked body 100 is cut (step S03). In the present embodiment, the stacked body 100 is cut by a cutting machine (for example, a dicing blade). Specifically, the stacked body 100 is cut on the basis of a cutting mark (not illustrated) provided on the stacked body 100. As a result, a plurality of green chips having a predetermined size are obtained.

Subsequently, the green chip is fired (step S04). By the firing of the green chip, the protrusions 30A and 30B and the recess 31 are melted in a portion where the conductor patterns CP overlap each other, and the conductor patterns CP are bonded (integrated) to each other. Therefore, after the green chip is fired, the protrusions 30A and 30B and the recess 31 may disappear in the portion where the conductor patterns CP overlap each other.

Then, a plating layer is formed on the surfaces of the terminal electrodes 4 and 5 (step S05). The plating layer is formed by, for example, electroplating or electroless plating. The plating layer contains, for example, Ni, Sn, or Au. As described above, the coil component 1 is obtained.

In the above manufacturing method, a case where the first green sheet GS1 and the second green sheet GS2 have the same configuration, that is, the second green sheet GS2 has the protrusions 30A and 30B and the recess 31 in the conductor pattern CP has been described as an example. However, the second green sheet GS2 may have a configuration having no protrusions 30A and 30B and no recess 31.

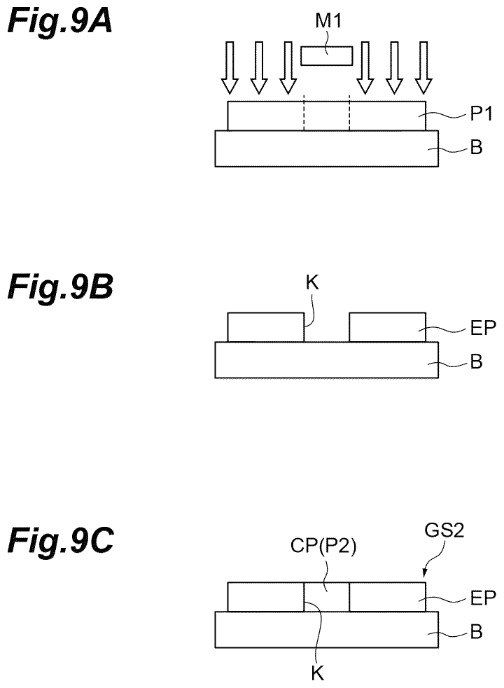

A method for forming the second green sheet GS2 having no protrusions 30A and 30B and no recess 31 will be described. In a step of forming the second green sheet GS2, first, an element-body pattern (second insulating layer) is formed. As illustrated in FIG. 9A, the element-body pattern is formed by applying the element-body paste P1 containing the constituent material of the insulator layer 6 and the photosensitive material onto the base material B. Subsequently, an element-body forming layer is exposed and developed by, for example, a photolithography method using a Cr mask M1, and as illustrated in FIG. 9B, the element-body pattern EP including the defective portion K obtained by removing the shape corresponding to the shape of the conductor pattern CP to be described later is formed on the base material.

Next, a conductor pattern (second conductor layer) is formed. As illustrated in FIG. 9C, for the conductor pattern, a conductor material layer is formed by applying the conductor paste P2 onto the element-body pattern EP. Specifically, the conductor material layer is formed in the defective portion K (including the base material B in the defective portion K) so as to be substantially flush with the surface S of the element-body pattern EP (so as to be flat). As a result, the conductor pattern CP corresponding to the shape of the defective portion K is formed. As described above, the second green sheet (second sheet) GS2 having the element-body pattern EP and the conductor pattern CP is formed.

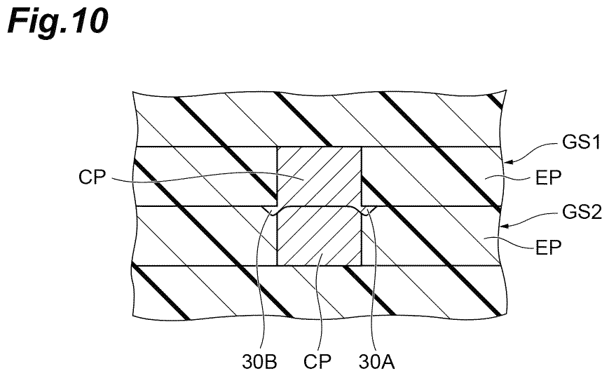

FIG. 10 is a cross-sectional view illustrating a part of the stacked body 100. In the example illustrated in FIG. 10, the first green sheet GS1 and the second green sheet GS2 are stacked adjacent to each other. As illustrated in FIG. 10, in the stacked body 100, the first green sheet GS1 and the second green sheet GS2 are stacked so that the conductor pattern CP of the first green sheet GS1 and the conductor pattern CP (no protrusions 30A and 30B and no recess 31) of the second green sheet GS2 overlap each other. The protrusions 30A and 30B of the conductor pattern CP of the first green sheet GS1 (second from the top in FIG. 10) bite into the conductor pattern CP of the second green sheet GS2 (third from the top in FIG. 10).

In addition, in the examples illustrated in FIGS. 8 and 10, the second green sheet (second sheet) GS2 adjacent to the first green sheet GS1 has the conductor pattern CP, but the second green sheet GS2 may not have the conductor pattern CP. That is, the second green sheet GS2 may include only the element-body pattern EP.

As described above, in the method for manufacturing the coil component 1 according to the present embodiment, the first green sheet GS1 having the conductor pattern CP is formed as at least one sheet of the plurality of green sheets. The conductor pattern CP has the protrusions 30A and 30B protruding from the surface S of the element-body pattern EP. As a result, in the method for manufacturing the coil component 1, when the first green sheet GS1 and another green sheet are stacked, the protrusions 30A and 30B of the conductor pattern CP bite into another green sheet. Therefore, in the method for manufacturing the coil component 1, the movement of the first green sheet GS1 in a direction (direction along the insulating layer of the green sheet) orthogonal to the stacking direction with respect to another green sheet can be restricted by an anchor effect. Therefore, in the method for manufacturing the coil component 1, stacking misalignment of the green sheets in the stacked body 100 can be suppressed.

In the method for manufacturing the coil component 1 according to the present embodiment, the protrusions 30A and 30B of the conductor pattern CP of the first green sheet GS1 bite into, for example, the conductor pattern CP of the adjacent second green sheet GS2. Therefore, in the method for manufacturing the coil component 1, the conductor patterns CP adjacent in the stacking direction are firmly connected to each other. Therefore, in the method for manufacturing the coil component 1, stacking misalignment of the green sheets in the stacked body 100 can be suppressed.

In the method for manufacturing the coil component 1 according to the present embodiment, the protrusions 30A and 30B of the conductor pattern CP of the first green sheet GS1 bite into, for example, the element-body pattern EP of the adjacent second green sheet GS2. Therefore, in the method for manufacturing the coil component 1, stacking misalignment of the green sheets in the stacked body 100 can be suppressed.

In the method for manufacturing the coil component 1 according to the present embodiment, in the first green sheet GS1, the protrusions 30A and 30B are formed so as to cover at least a part of the edge of the element-body pattern EP forming the defective portion K in the element-body pattern EP. In this method, the edge portions 30Ae and 30Be are formed in the protrusions 30A and 30B. Therefore, the bonding strength between the element-body pattern EP and the conductor pattern CP can be improved.

In the method for manufacturing the coil component 1 according to the present embodiment, the element-body pattern EP having the recess 31 recessed from the surface S of the element-body pattern EP is formed in the first green sheet GS1. In this method, the surface area of the conductor pattern CP can be increased by forming the recess 31 in the conductor pattern CP.

Although the embodiment of the present invention has been described above, the present invention is not necessarily limited to the above-described embodiment, and various modifications can be made without departing from the gist thereof.

In the above embodiment, the form in which the electronic component is a coil component has been described as an example. However, the electronic component manufactured by the method for manufacturing an electronic component according to the present invention may be a capacitor component or the like.

In the above embodiment, the form in which the conductor pattern CP of the first green sheet GS1 has the recess 31 has been described as an example. However, the conductor pattern CP may not have the recess. A region between the two protrusions 30A and 30B may be flat, and in this case, the region may be at the same height position as the surface S of the element-body pattern EP.

In the above embodiment, the form in which the conductor pattern CP of the first green sheet GS1 has the two protrusions 30A and 30B has been described as an example. However, the shape of the protrusion is not limited thereto. For example, the number of protrusions may be one.

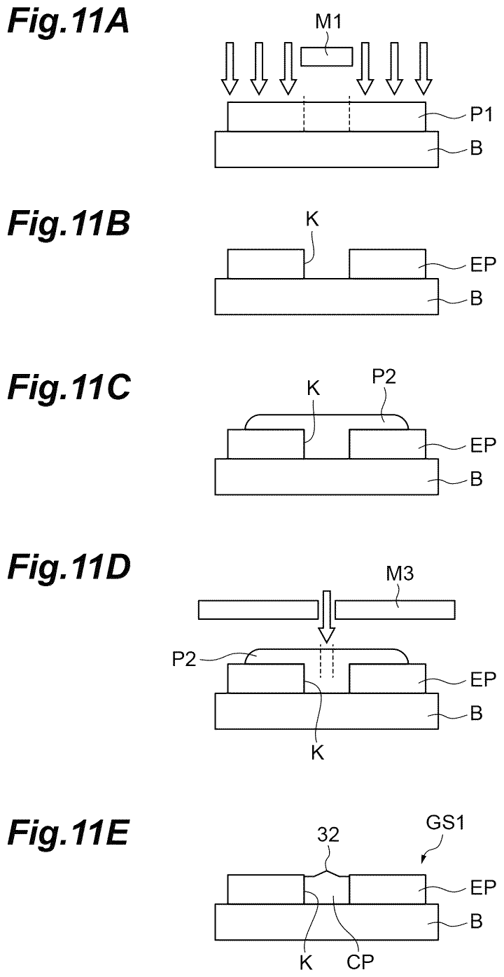

Hereinafter, a method for manufacturing a green sheet for a coil component according to another embodiment will be described. As illustrated in FIG. 11A, an element-body pattern is formed by applying an element-body paste P1 onto a base material B. Subsequently, an element-body forming layer is exposed and developed by, for example, a photolithography method using a Cr mask M1, and as illustrated in FIG. 11B, the element-body pattern EP including a defective portion K obtained by removing a shape corresponding to the shape of a conductor pattern CP is formed on the base material.

Next, as illustrated in FIG. 11C, a conductor material layer is formed by applying a conductor paste P2 onto the element-body pattern EP. Specifically, the conductor material layer is formed on the element-body pattern EP and the defective portion K (including the base material B in the defective portion K). Next, as illustrated in FIG. 11D, the conductor material layer is exposed and developed by a photolithography method using a mask M3 corresponding to the defective portion K. As a result, as illustrated in FIG. 11E, the conductor pattern CP corresponding to the shape of the defective portion K is formed.

As described above, the first green sheet (first sheet) GS1 having the element-body pattern EP and the conductor pattern CP is formed. In the first green sheet GS1, the conductor pattern CP has a protrusion 32. In the example illustrated in FIG. 11E, the conductor pattern CP has one protrusion 32. The protrusion 32 protrudes from a surface S of the element-body pattern EP.

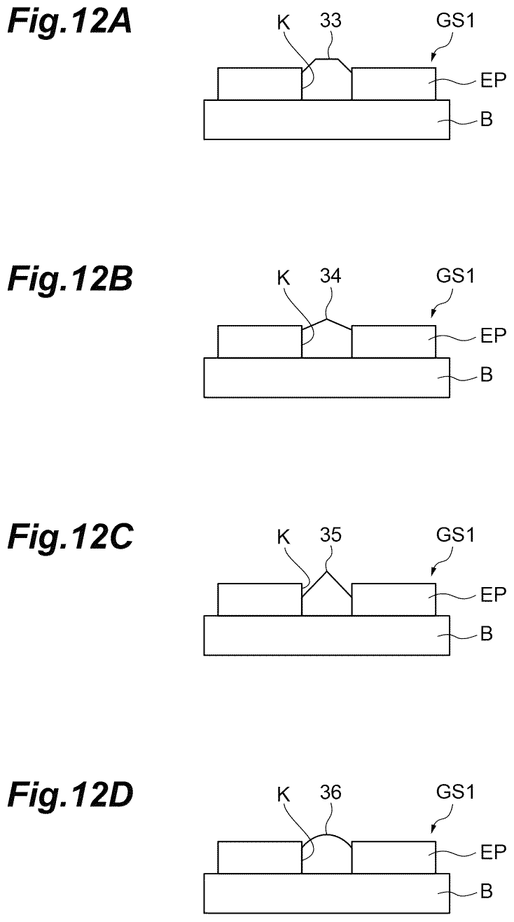

In the first green sheet GS1, as an example of one protrusion, a protrusion 33 in which a cross-sectional shape of an upper portion of the conductor pattern CP is a trapezoidal shape may be used as illustrated in FIG. 12A, a protrusion 34 in which the cross-sectional shape of the upper portion of the conductor pattern CP is a triangular shape may be used as illustrated in FIG. 12B, a protrusion 35 in which the cross-sectional shape of the upper portion of the conductor pattern CP is a triangular shape may be used as illustrated in FIG. 12C, or a protrusion 36 in which the cross-sectional shape of the upper portion of the conductor pattern CP is a semicircular shape may be used as illustrated in FIG. 12D.

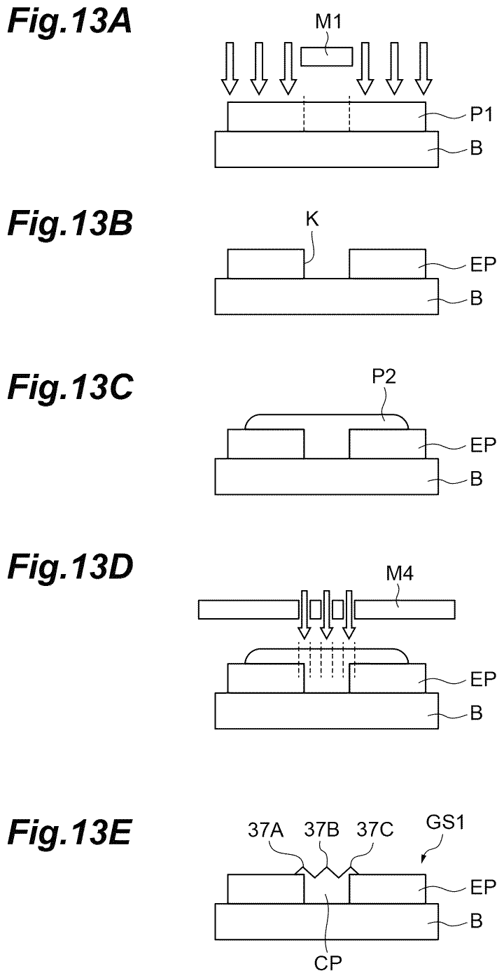

In addition, three or more protrusions may be provided. Hereinafter, a method for manufacturing a green sheet for a coil component according to another embodiment will be described. As illustrated in FIG. 13A, an element-body pattern is formed by applying an element-body paste Pl onto a base material B. Subsequently, an element-body forming layer is exposed and developed by, for example, a photolithography method using a Cr mask M1, and as illustrated in FIG. 13B, the element-body pattern EP including a defective portion K obtained by removing a shape corresponding to the shape of a conductor pattern CP is formed on the base material.

Next, as illustrated in FIG. 13C, a conductor material layer is formed by applying a conductor paste P2 onto the element-body pattern EP. Specifically, the conductor material layer is formed on the element-body pattern EP and the defective portion K (including the base material B in the defective portion K). Next, as illustrated in FIG. 13D, the conductor material layer is exposed and developed by a photolithography method using a mask M4 corresponding to the defective portion K. As a result, as illustrated in FIG. 13E, the conductor pattern CP corresponding to the shape of the defective portion K is formed.

As described above, a first green sheet GS1 having the element-body pattern EP and the conductor pattern CP is formed. In the first green sheet GS1, the conductor pattern CP has protrusions 37A, 37B, and 37C. In the example illustrated in FIG. 13E, the conductor pattern CP has three protrusions 37A, 37B, and 37C. The protrusions 37A, 37B, and 37C protrude from a surface S of the element-body pattern EP.

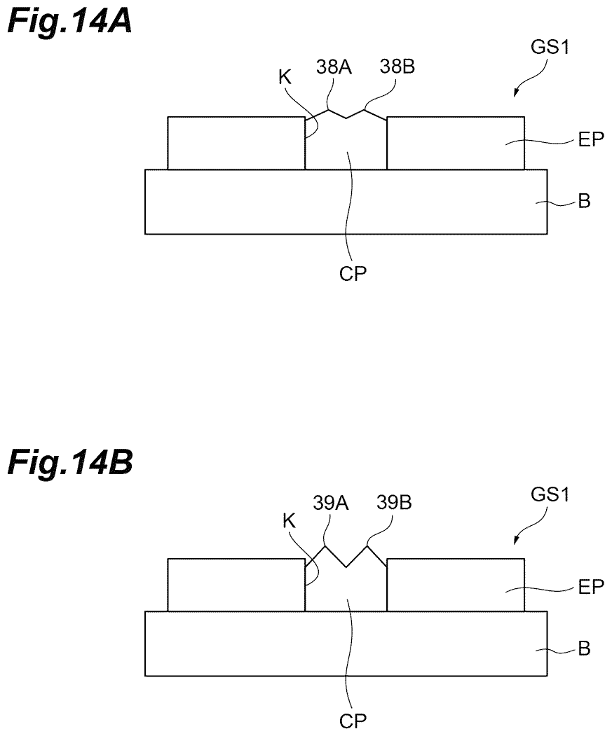

In the above embodiment, the form in which the conductor pattern CP of the first green sheet GS1 has the edge portions 30Ae and 30Be in the protrusions 30A and 30B has been described as an example. However, the protrusion may not have the edge portion. The conductor pattern CP may have protrusions 38A and 38B as illustrated in FIG. 14A, or the conductor pattern CP may have protrusions 39A and 39B as illustrated in FIG. 14B.

In the above embodiment, the form in which the conductor patterns of the electrode layers 10, 11, 12, and 13 constituting the terminal electrodes 4 and 5 are formed in the step of forming the conductor pattern (step S02 in FIG. 4) has been described as an example. However, depending on the configuration of the terminal electrode, the terminal electrode may be formed after firing of the green chip.

In the above embodiment, the form in which the plating layer is formed on the surfaces of the terminal electrodes 4 and 5 (step S05 in FIG. 4) after the step of firing the green chip (step S04 in FIG. 4) has been described as an example. However, the plating layer may not be 10 formed on the surfaces of the terminal electrodes 4 and 5.

In the above embodiment, the shapes of the terminal electrodes 4 and 5 can be appropriately changed according to the design. In addition, the shape of the coil 9 and the number of coil conductors can be appropriately changed according to the design.

What is claimed is:

1. A method for manufacturing an electronic component, comprising:
a step of forming a plurality of sheets; and
a step of stacking the plurality of sheets to form a stacked body, wherein
in the step of forming the plurality of sheets, a process of forming, using an insulating paste, a first insulating layer having an opening and a process of forming, using a conductor paste, a first conductor layer having a protrusion protruding from a surface of the first insulating layer in the opening of the first insulating layer are performed to form at least one first sheet of the plurality of sheets,
the first conductor layer includes a plurality of regions having different height positions with respect to the surface of the first insulating layer, and
the protrusion is formed in the first conductor layer by the region protruding from the surface of the first insulating layer in the plurality of regions.

2. The method for manufacturing an electronic component according to claim 1, wherein
in the step of forming the plurality of sheets, a process of forming, using an insulating paste, a second insulating layer having an opening and a process of forming, using a conductor paste, a second conductor layer in the opening of the second insulating layer are performed to form at least one second sheet of the plurality of sheets, and
in the step of forming the stacked body, the first sheet and the second sheet are stacked so that the protrusion of the first conductor layer of the first sheet overlaps the second conductor layer of the second sheet.

3. The method for manufacturing an electronic component according to claim 1, wherein
in the step of forming the plurality of sheets, a process of forming a second insulating layer using an insulating paste is performed to form at least one second sheet of the plurality of sheets, and
in the step of forming the stacked body, the first sheet and the second sheet are stacked so that the protrusion of the first conductor layer of the first sheet overlaps the second insulating layer of the second sheet.

4. The method for manufacturing an electronic component according to claim 1, wherein
in the step of forming the plurality of sheets, a process of forming a third insulating layer using an insulating paste is performed to form at least one third sheet of the plurality of sheets, and
the third sheet is stacked so as to be an outermost layer in a stacking direction of the stacked body, and an outer surface of the stacked body is configured by the third sheet.

5. The method for manufacturing an electronic component according to claim 1, wherein in the first sheet, the protrusion is formed so as to cover at least a part of an edge of the first insulating layer forming the opening in the first insulating layer.

6. The method for manufacturing an electronic component according to claim 1, wherein
the first conductor layer having a recess recessed from the surface of the first insulating layer is formed in the first sheet, and
the recess is formed in the first conductor layer by the region recessed from the surface of the first insulating layer in the plurality of regions.

7. The method for manufacturing an electronic component according to claim 1, wherein the first conductor layer constitutes a coil conductor.
